(19) United States
(12) Patent Application Publication
(10) Pub. No.: US 2026/0194644 A1
(43) Pub. Date: Jul. 9, 2026

(54) RADAR TRANSCEIVER ARRANGEMENT

(71) Applicant: Robert Bosch GmbH, Stuttgart (DE)

(72) Inventors: Carsten Naber, Gerlingen (DE); Juergen Hasch, Stuttgart (DE)

(21) Appl. No.: 19/134,297

(22) PCT Filed: Jan. 23, 2024
(86) PCT No.: PCT/EP2024/051511

§ 371 Date: May 30, 2025

(30) Foreign Application Priority Data
Mar. 30, 2023 (DE) 10 2023 202 898.0

(51) Int. Cl. G01S 13/34; G01S 7/35; G01S 13/38

(52) U.S. Cl. CPC G01S 13/347; G01S 7/354; G01S 7/358; G01S 13/38

(57) ABSTRACT

A radar transceiver arrangement for generating modulated multi-tone chirp signals. The radar transceiver arrangement including a transmitting device with at least two digital chirp generators, which each generate a complex, digital chirp signal with configurable parameters, and at least two transmission paths, for which each of the chirp generators generates a signal by combining the chirp signals, which is converted to analog via a digital-to-analog converter for the transmission of radar signals by a transmitting antenna.

### FIELD

The present invention relates to a radar transceiver arrangement for generating modulated multi-tone chirp signals.

### BACKGROUND INFORMATION

Such radar transceiver arrangements are used, for example, in vehicles, to implement driver assistance systems and driving safety systems.

The use of a chirp sequence modulation method in combination with a MIMO (multiple-input multiple-output) radar system is also used according to the related art. A chirp signal is transmitted via several transmitting antennas and the reflection is received via several receiving antennas. Various multiplexing methods, such as TDM (time-division multiplexing), FDM (frequency-division multiplexing), or DDM (Doppler-division multiplexing), are used to enable multiplexing of several transmitting antennas. In addition, there are radar sensors that enable transmit beam steering, in which the same modulation signal is transmitted on several transmitters, but with different phase and amplitude.

The necessary chirp signals are typically generated with analog components, such as voltage-controlled oscillators (VCOs). To enable modulations such as DDM or TX beam steering, analog phase shifters are used to modulate the phase of the analog chirp signals. The reflections are mixed analog with the transmitted chirp signal, low-pass filtered, and then converted analog-to-digital. The signals digitized in this way are then further processed with digital signal processing methods.

### SUMMARY

The present invention provides a radar transceiver arrangement for generating modulated multi-tone chirp signals. According to an example embodiment of the present invention, the radar transceiver arrangement includes a transmitting device with at least two digital chirp generators, which each generate a complex, digital chirp signal with configurable parameters, and which comprises at least two transmission paths, for which each of the chirp generators generates a signal by combining the chirp signals, which is converted to analog via a digital-to-analog converter for the transmission of radar signals via a transmitting antenna, enables an efficient and flexibly configurable implementation of a chirp sequence radar, which enables a frequency division multiplex of differently modulated chirp signals in a MIMO system.

A main aspect of the present invention is the implementation of a hardware architecture for the efficient digital generation of modulated multi-tone chirp signals as well as an associated hardware architecture for efficient digital demodulation of the reflected chirp signals.

It is also a main aspect of the present invention that processing of the chirp signals occurs digitally. On the one hand, this relates to the purely digital generation of the modulation. The digital signal is then converted via digital-to-analog converters and converted to the radar frequency band in an IQ mixer. The proportion of costly and toleranced analog components is kept to a minimum while maximizing flexibility of modulation beyond conventional signal generation methods. This is particularly advantageous for multi-tone signals, where an analog implementation would be very complex, whereas a digital implementation makes good use of the high number of degrees of freedom.

According to an aspect of the present invention, a receiving device with at least two receiving antennas is provided for receiving at least two chirp signals reflected from an object, which are each fed to an analog-to-digital converter and are digitally mixed with at least one of the transmitted chirp signals in at least one receiving path assigned to each receiving antenna by means of a complex multiplier. In line with the method for signal transmission, the received reflected chirp signals are only digitally mixed with the transmitted chirp signals in the complex baseband and processed further after the analog-to-digital conversion. Compared to an analog mix, this also reduces the complexity of the analog part of the receiving path for multi-tone signals, as only one analog quadrature mixer is required even for several tones.

The configurable parameters include at least the start phase, the start frequency, the ramp slope, and the ramp length.

The local oscillator required for mixing into the transmission frequency band is typically operated at a fixed frequency or in a few discrete frequency steps (typically 2 . . . 16). This makes it possible to increase the overall bandwidth of the radar transmission or, for example, to avoid interference signals.

However, the frequency of the local oscillator is not changed during the transmission of a chirp.

According to an aspect of the present invention, the chirp signals are each weighted with an individual complex parameter before the chirp signals are combined in the transmission paths. The configurable parameters may include this individual complex parameter.

According to an aspect of the present invention, it is provided that the mixing of the at least two reflected chirp signals with the transmitted chirp signals takes place after inversion of the frequency.

A further aspect of the present invention provides for low-pass filtering of the mixed signals and a reduction in the sampling rate.

Instead of at least a second chirp generator, a complex sine tone generator and at least one additional mixer may also be provided.

According to one aspect of the present invention, it is provided that in each receiving path, the received chirp signals are separated in a filter bank set up for this purpose.

### BRIEF DESCRIPTION OF THE DRAWINGS

Exemplary embodiments of the present invention are shown in the figures and explained in more detail in the following description.

FIG. 1 shows a transmitting device according to an example embodiment of the present invention with at least two digital chirp generators.

FIG. 2 shows a receiving device according to an example embodiment of the present invention with at least two receiving antennas for receiving at least two chirp signals reflected from an object.

FIG. 3 shows the expansion of a transmitting device according to an example embodiment of the present invention with three digital chirp generators.

FIG. 4 shows a cascade structure for generating several frequency-shifted chirp signals, according to an example embodiment of the present invention.

FIG. 5 shows the expansion of a receiving device according to an example embodiment of the present invention for demodulating reflected radar signals with more than two tones.

FIG. 6 shows the separation of the individual tones of a multi-tone chirp signal using a “polyphase channelizer,” according to an example embodiment of the present invention.

### DETAILED DESCRIPTION OF EXAMPLE EMBODIMENTS

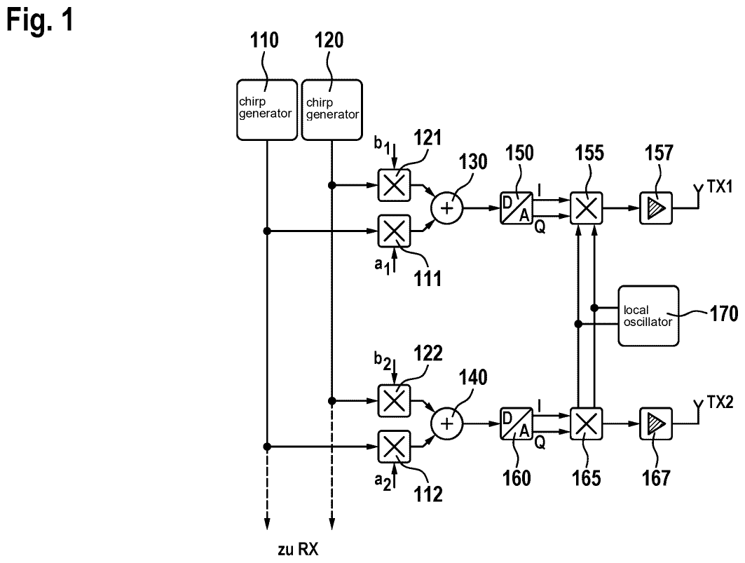

FIG. 1 shows the basic form of a hardware architecture for generating modeled multi-tone chirp signals consisting of two tones. Two digital chirp generators 110, 120 are provided. These can independently generate a complex digital chirp signal with configurable parameters. For example, these configurable parameters can be the start frequency, the start phase, the ramp slope, or the ramp length. Each of these chirp signals may be multiplied by a complex parameter aₓ, bₓ independently for each transmitting antenna TX1 or TX2 of the radar, as shown using the multipliers 111, 112, 121, 122. A number of TX antennas multiplied by two complex multipliers are provided for this purpose. In this way, two chirp signals with configurable amplitude and phase position are obtained per transmitting antenna. Depending on the desired modulation, it is sufficient if the complex parameter is only changed from ramp to ramp (for example, DDM or TX beam steering) or it can also be changed during the transmission of the ramp for other types of modulation, e.g., code division multiplex CDM, if designed accordingly. In principle, all types of modulation based on modulation of the amplitude and/or phase of the chirp signal can be implemented. For each of the transmitting antennas TX1, TX2, the modulated chirp signals are added. Adders 130, 140 are provided for this purpose. In this way, an individually modulated multi-tone chirp signal is obtained for each transmitting antenna TX1, TX2. These digital multi-tone chirp signals are converted into analog signals by digital-to-analog converters 150, 160. For each of the transmitting antennas TX1, TX2 there are two analog signals, which represent the in-phase (I) and quadrature components (Q) of the multi-tone chirp signal. These signals are converted to the desired radar frequency band using a quadrature mixer 155, 165, for which a local oscillator 170 is used, amplified using amplifiers 157, 167 and transmitted via the antennas TX1, TX2.

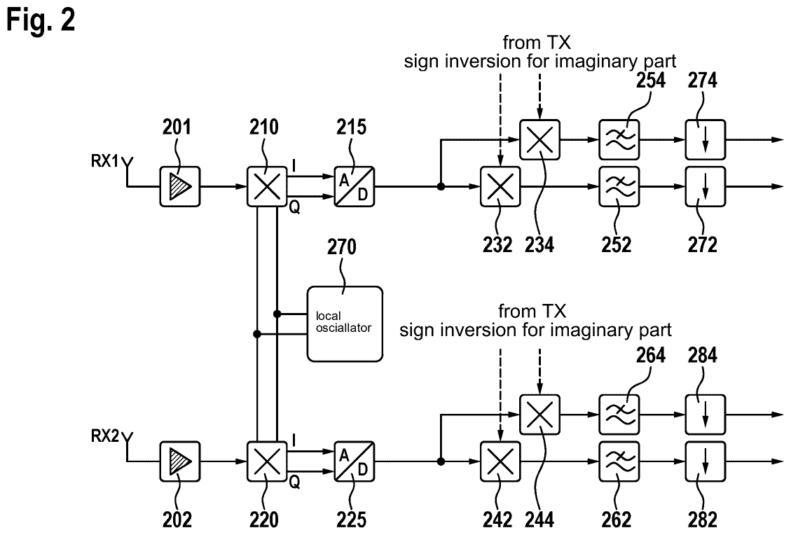

The receiving path is shown in FIG. 2. In the receiving path, the reflected analog radar signals received by antennas RX1, RX2 are amplified by means of amplifiers 201, 202 and converted into the complex baseband for each receiving antenna RX1, RX2 by means of a quadrature mixer 210, 220. Mixing is performed using the local oscillator 270. These signals are then converted into digital signals by analog-to-digital converters 215, 225. The receiving path of each receiving antenna RX1, RX2 is now divided into two paths. Each of these paths contains a complex multiplier 232, 234 or 242, 244, respectively, which mixes the received signal with one of the chirp signals generated on the transmitting side, albeit with a negated frequency. The negated frequency is realized, for example, by inversion of the sign of the imaginary part. These signals are then digitally low-pass filtered by corresponding low-pass filters 252, 254 or 262, 264, respectively, and the sampling rate is reduced by decimators 272, 274 or 282, 284, respectively. This provides a separate signal for each receiving antenna RX1, RX2 and for each individual transmission tone, which can be further processed using conventional digital radar signal processing methods.

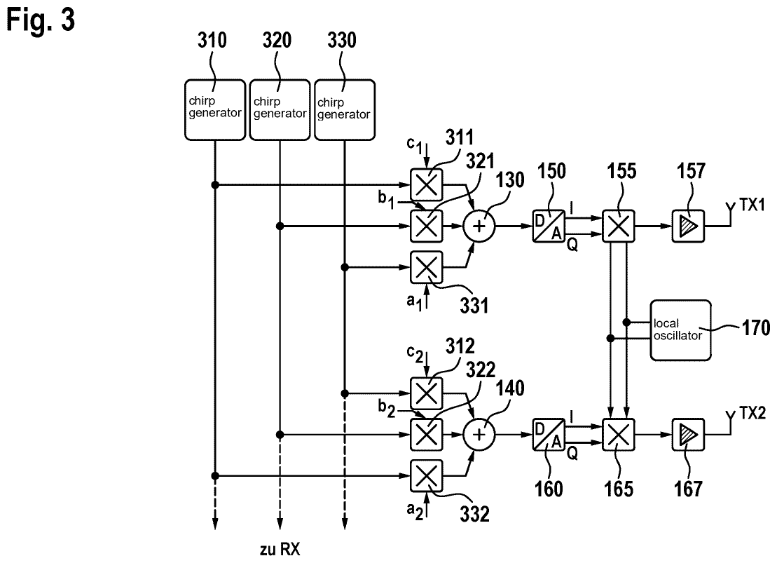

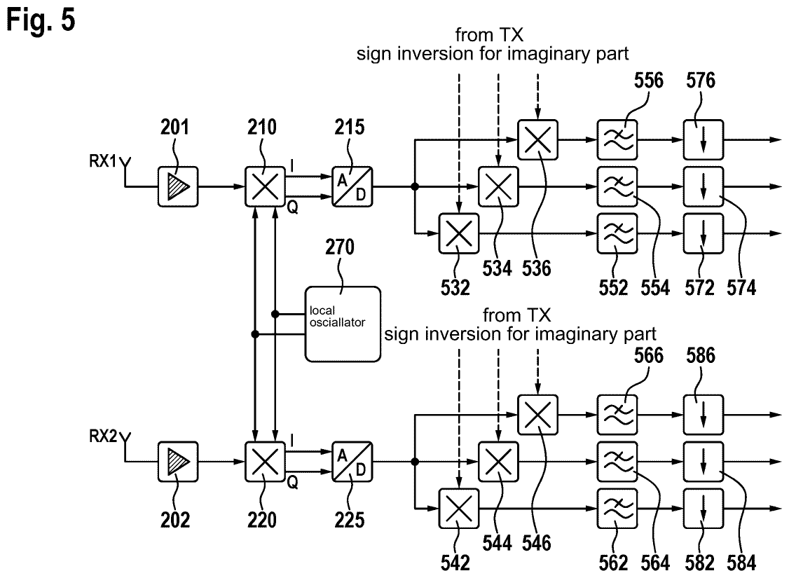

An expansion to more than two tones is shown in FIGS. 3 and 5. The same elements are shown with the same reference symbols as in FIG. 1 and FIG. 2. FIG. 3 and FIG. 5 show the expansion to three tones. In FIG. 3, three digital chirp generators 310, 320, 330 are provided for this purpose, wherein the number of multipliers has been increased accordingly to three, 311, 321, 331 or 312, 322, 332, respectively. For each transmitting antenna TX1, TX2, these three modulated chirp signals are added in adders 130, 140 and further processing is carried out as described in connection with FIG. 1.

The receiving path essentially corresponds to that shown in FIG. 2, wherein here, three complex multipliers 532, 534, 536 or 542, 544, 546, respectively, are provided and low-pass filtering takes place in three low-pass filters 552, 554, 556 or 562, 564, 566, respectively. Three decimators 582, 584, 586 or 572, 574, 576, respectively, are connected downstream of the low-pass filters to reduce the sampling rate.

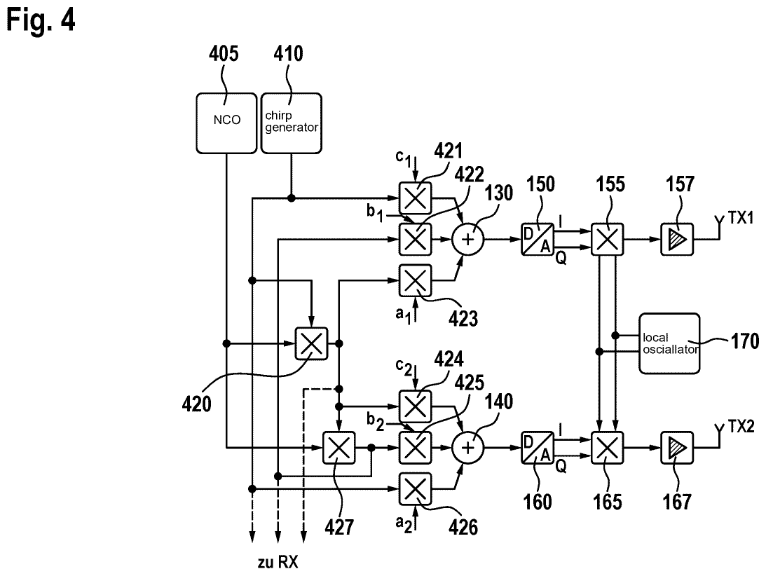

If a large number of tones are to be generated, it may make sense to reduce the amount of hardware required and use a cascade structure, as shown in FIG. 4. Here, only a chirp signal is generated by a digital chirp generator 410 and a complex sine tone with a constant frequency is generated with the aid of a numerically controlled oscillator (NCO) 405. These signals are digitally mixed together several times, which is done with the help of multipliers 420, 421, 422, 423, 424, 425, 426, and 427. This multiple digital mixing is performed to obtain several equidistantly frequency-shifted chirp signals with the same bandwidth and ramp slope. Regardless of the number of tones, in this case only one digital chirp generator 410 and one complex sine tone generator (Numerically Controlled Oscillator-NCO) 405 is needed, wherein the number of multipliers required (420 to 427) increases with the number of tones, however. Further signal processing is carried out as described in connection with FIG. 1.

On the receiving side, which is shown schematically in FIG. 5, a higher number of tones can be processed-as already explained above-in which the path is replicated with mixers and low-pass filters according to the number of tones. Each path is then mixed with the tone that is to be separated.

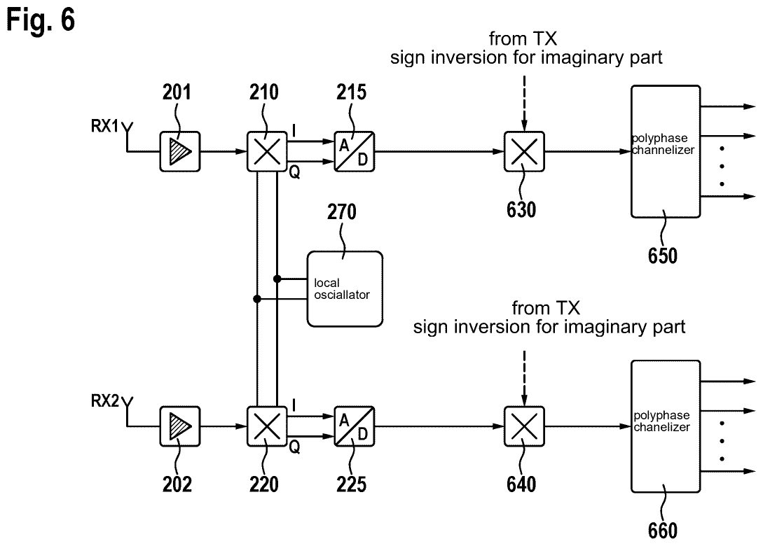

As an alternative to the circuit shown in FIG. 5, the individual tones of a multi-tone chirp signal can be separated by means of so-called polyphase channelizers 650, 660, as shown schematically in FIG. 6, in which the same elements are designated with the same reference signs as in FIG. 2, such that reference is made to the description of FIG. 2 for their description. In multipliers 630, 640, the sign inversion of the imaginary part is carried out as described above and the individual tones are separated in the polyphase channelizers 650, 660 mentioned above.

1-10. (canceled)

11. A radar transceiver arrangement for generating modulated multi-tone chirp signals, comprising:
a transmitting device including at least two digital chirp generators, which are each configured to generate a complex, digital chirp signal with configurable parameters, and at least two transmission paths, for which each of the chirp generators generates a signal by combining the chirp signals, which is converted to analog via a digital-to-analog converter for transmission of radar signals via a transmitting antenna.

12. The radar transceiver arrangement according to claim 11, further comprising:
a receiving device including at least two receiving antennas for receiving at least two chirp signals reflected from an object, which are each fed to an analog-to-digital converter and are digitally mixed with at least one of the transmitted chirp signals in at least one receiving path assigned to each receiving antenna, using a complex multiplier.

13. The radar transceiver arrangement according to claim 11, wherein a conversion of the signals between complex baseband and radar frequency band is performed in the transmitting device and in the receiving device via a quadrature mixer and a local oscillator.

14. The radar transceiver arrangement according to claim 11, wherein the configurable parameters comprise at least: a start phase, a start frequency, a ramp slope, a ramp length.

15. The radar transceiver arrangement according to claim 11, wherein before combining the chirp signals in the transmission paths, each of the chirp signals is weighted with an individual complex parameter.

16. The radar transceiver arrangement according to claims 15, wherein the configurable parameters include the individual complex parameters.

17. The radar transceiver arrangement according to claim 12, wherein the mixing of the at least two reflected chirp signals with the transmitted chirp signals takes place after inversion of a frequency.

18. The radar transceiver arrangement according to claim 12, wherein low-pass filters, in which low-pass filtering of the mixed reflected chirp signals takes place, and decimators, in which a sampling rate reduction takes place, are provided in the receiving paths.

19. A radar transceiver arrangement for generating modulated multi-tone chirp signals, comprising:
a transmitting device including a digital chirp generator configured to generate a complex, digital chirp signal with configurable parameters, a complex sine tone generator, and at least one mixer, the mixer configured to generate a signal by digitally mixing the digital chirp signal and a signal from the complex sine tone generator, the signal of the mixer being converted to analog via a digital-to-analog converter for transmission of radar signals via a transmitting antenna.

20. The radar transceiver arrangement according to claim 12, wherein in each of the receiving paths, a separation of the received chirp signals takes place in a filter bank set up for this purpose.
